(19) United States
(12) Patent Application Publication
(10) Pub. No.: US 2025/0014576 A1
(43) Pub. Date: Jan. 9, 2025

(54) SPEECH RECOGNITION DEVICE AND COMPUTER-READABLE STORAGE MEDIUM

(71) Applicant: FANUC CORPORATION, Yamanashi (JP)

(72) Inventors: Yasuhiro SHIBASAKI, Yamanashi (JP); Kazuhiro SATOU, Yamanashi (JP)

(21) Appl. No.: 18/709,812

(22) PCT Filed: Nov. 30, 2021
(86) PCT No.: PCT/JP2021/043834

§ 371 Date: May 14, 2024

(51) Int. Cl. G10L 15/22; G10L 15/01

(52) U.S. Cl. CPC G10L 15/22; G10L 15/01; G10L 2015/223

(57) ABSTRACT

This speech recognition device comprises: a speech acceptance unit for accepting speech information representing one command among a plurality of commands; a speech recognition unit for performing speech recognition of the one command on the basis of the speech information accepted by the speech acceptance unit and for computing a reliability score for the recognition result of the one command; a condition storage unit for storing a plurality of conditions used in determining whether to execute a verification process for a recognition result, in association with a plurality of respective commands; a determination unit for determining whether to execute a verification process on the basis of one condition among a plurality of conditions stored in the condition storage unit and the reliability score computed by the speech recognition unit; and an output unit for outputting the recognition result without executing the verification process in a case where the determination unit determined to not execute the verification process.

### TECHNICAL FIELD

The present disclosure relates to a speech recognition device and a computer-readable storage medium.

### BACKGROUND ART

A known speech recognition device recognizes uttered speech, converts the recognized speech into text, and calculates the reliability of the information converted into text. In this type of speech recognition device, a confirmation process is executed to request confirmation of the information converted into text, depending on the calculated reliability (for example, PTL 1). More specifically, when the reliability is low, the speech recognition device requests a user to confirm whether or not the information converted into text is correct, and when the reliability is high, execution of the confirmation process is omitted. Thus, the number of operations performed by the user on the speech recognition device can be reduced, enabling an improvement in the user-friendliness of the speech recognition device.

### CITATION LIST

### Patent Literature

[PTL 1] Japanese Patent Laid Open No. 2008-233305

### SUMMARY OF INVENTION

### Technical Problem

However, with a conventional speech recognition device, whether or not to perform the confirmation process is determined regardless of the importance of the content indicated by the information that has been converted into text through speech recognition. Therefore, the confirmation process may be executed even when the importance of the content indicated by the information converted into text is low, for example. Accordingly, there is a need to further improve the user-friendliness of a speech recognition device.

An object of the present disclosure is to provide a speech recognition device having improved user-friendliness.

### Solution to Problem

A speech recognition device includes a speech reception unit for receiving speech information indicating a single command among a plurality of commands, a speech recognition unit for performing speech recognition on the single command on the basis of the speech information received by the speech reception unit, and calculating a reliability of a recognition result of the single command, a condition storage unit for storing a plurality of conditions that are used to determine whether or not to execute a confirmation process on the recognition result respectively in association with the plurality of commands, a determination unit for determining whether or not to execute the confirmation process on the basis of one condition among the plurality of conditions stored in the condition storage unit and the reliability calculated by the speech recognition unit, and an output unit for outputting the recognition result without executing the confirmation process when the determination unit determines that the confirmation process is not to be executed.

A computer-readable storage medium stores commands for causing a computer to execute receiving speech information indicating a single command among a plurality of commands, performing speech recognition on the single command on the basis of the received speech information, and calculating a reliability of a recognition result of the single command, determining whether or not to execute a confirmation process on the basis of one condition among a plurality of conditions that are used to determine whether or not to execute a confirmation process on the recognition result, the plurality of conditions being stored respectively in association with the plurality of commands, and the calculated reliability, and outputting the recognition result without executing the confirmation process when it is determined that the confirmation process is not to be executed.

### Advantageous Effects of Invention

According to an aspect of the present disclosure, it is possible to provide a speech recognition device having improved user-friendliness.

### BRIEF DESCRIPTION OF DRAWINGS

FIG. 1 is a block diagram showing an example of a hardware configuration of a machine tool;

FIG. 2 is a block diagram showing examples of functions of a speech recognition device;

FIG. 3 is a block diagram showing examples of functions of a speech recognition unit;

FIG. 4 is a diagram showing examples of commands and conditions stored by a condition storage unit;

FIG. 5 is a diagram showing an example of a confirmation screen displayed in a confirmation process;

FIG. 6 is a flowchart showing an example of processing executed at a preparatory stage;

FIG. 7 is a flowchart showing an example of processing executed at an operation stage; and

FIG. 8 is a block diagram showing examples of functions of a speech recognition device that includes an updating unit.

### DESCRIPTION OF EMBODIMENTS

A speech device according to an embodiment of the present disclosure will be described below using the figures. Note that not all combinations of the features to be described in the following embodiment are necessarily required to solve the problem. Moreover, unnecessarily detailed description may be omitted. Furthermore, the following description of the embodiment and the figures are provided so that a person skilled in the art can sufficiently understand the present disclosure, and are not intended to limit the scope of the claims.

A speech recognition device is a device for performing speech recognition. Speech recognition is processing for converting uttered speech into text. The concept of speech recognition may also include converting uttered speech into information that can be understood by a computer.

A speech recognition device is packaged in a numerical controller for controlling industrial machinery, for example. The speech recognition device may be packaged in a server, a personal computer (PC), or a mobile tablet, which is connected either wirelessly or by wire to the numerical controller.

The industrial machinery includes a machine tool, an injection molding machine, a wire electrical discharge machine, and an industrial robot. The machine tool is a lathe, a machining center, a drilling center, or a multitasking machine, for example. An embodiment in which the speech recognition device is packaged in a numerical controller for controlling a machine tool will be described below.

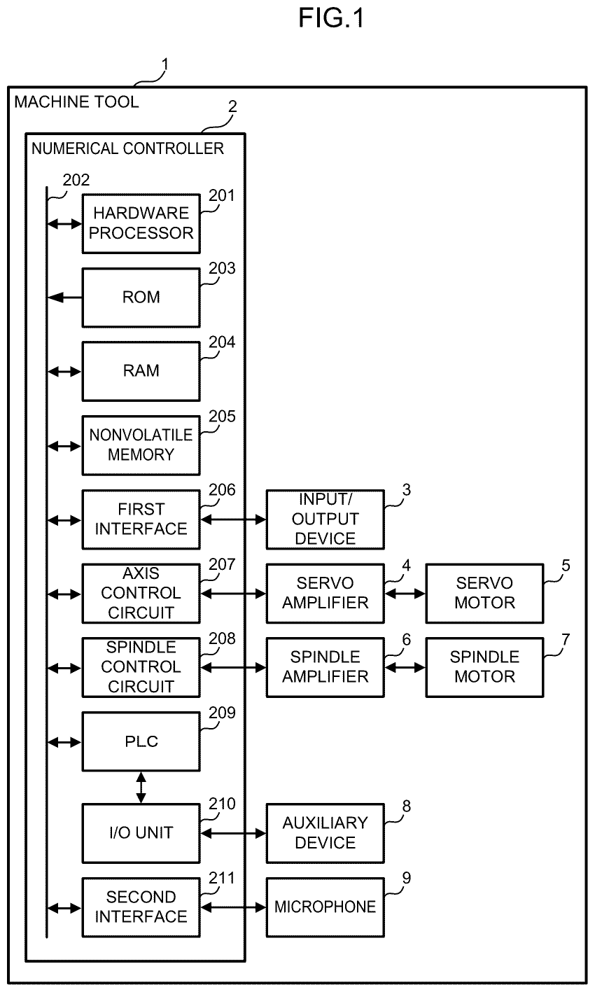

FIG. 1 is a block diagram showing an example of a hardware configuration of a machine tool including a numerical controller.

A machine tool 1 includes a numerical controller 2, an input/output device 3, a servo amplifier 4, a servo motor 5, a spindle amplifier 6, a spindle motor 7, an auxiliary device 8, and a microphone 9.

The numerical controller 2 is a device for controlling the entire machine tool 1. The numerical controller 2 includes a hardware processor 201, a bus 202, a read only memory (ROM) 203, a random access memory (RAM) 204, and a nonvolatile memory 205.

The hardware processor 201 is a processor for controlling the entire numerical controller 2 in accordance with a system program. The hardware processor 201 reads the system program, which is stored in the ROM 203, via the bus 202, and performs various processing on the basis of the system program. The hardware processor 201 controls the servo motor 5 and the spindle motor 7 on the basis of a machining program. The hardware processor 201 is a central processing unit (CPU) or an electronic circuit, for example.

The hardware processor 201 analyzes the machining program and outputs control commands to the servo motor 5 and the spindle motor 7, for example, at intervals of a control period.

The bus 202 is a communication line connecting the hardware components in the numerical controller 2 to each other. The hardware components in the numerical controller 2 exchange data via the bus 202.

The ROM 203 is a storage device that stores the system program for controlling the entire numerical controller 2, and so on. The ROM 203 may also store a speech recognition program. The ROM 203 is a computer-readable storage medium.

The RAM 204 is a storage device for temporarily storing various data. The RAM 204 functions as a working area used by the hardware processor 201 to process various data.

The nonvolatile memory 205 is a storage device that holds data even in a state where a power supply of the machine tool 1 has been disconnected such that power is not supplied to the numerical controller 2. The nonvolatile memory 205 stores the machining program and various parameters, for example. The nonvolatile memory 205 is a computer-readable storage medium. The nonvolatile memory 205 is constituted by a memory backed up by a battery or a solid state drive (SSD), for example.

The numerical controller 2 further includes a first interface 206, an axis control circuit 207, a spindle control circuit 208, a programmable logic controller (PLC) 209, an I/O unit 210, and a second interface 211.

The first interface 206 is an interface connecting the bus 202 and the input/output device 3. The first interface 206 sends the various data processed by the hardware processor 201 to the input/output device 3, for example.

The input/output device 3 is a device for receiving various data through the first interface 206 and displaying various data. Further, the input/output device 3 receives input of the various data, and sends the various data to the hardware processor 201, for example, through the first interface 206.

The input/output device 3 is a touch panel, for example. When the input/output device 3 is a touch panel, the input/output device 3 is an electrostatic capacitance-type touch panel, for example. Note that the touch panel is not limited to an electrostatic capacitance-type touch panel, and may be another type of touch panel. The input/output device 3 is disposed on an operating panel (not shown) in which the numerical controller 2 is stored.

The axis control circuit 207 is a circuit for controlling the servo motor 5. The axis control circuit 207 receives a control command from the hardware processor 201 and outputs a command for driving the servo motor 5 to the servo amplifier 4. The axis control circuit 207 sends a torque command for controlling the torque of the servo motor 5, for example, to the servo amplifier 4.

The servo amplifier 4 receives the command from the axis control circuit 207 and supplies a current to the servo motor 5.

The servo motor 5 is driven upon receipt of the current supply from the servo amplifier 4. The servo motor 5 is coupled to a ball screw for driving a tool rest, for example. When the servo motor 5 is driven, a structure of the machine tool 1, such as the tool rest, moves in directions of respective control axes. The servo motor 5 has an inbuilt encoder (not shown) for detecting the position and the feed speed of each control axis. Position feedback information and speed feedback information respectively indicating the positions of the control axes and the feed speeds of the control axes, detected by the encoder, are fed back to the axis control circuit 207. Thus, the axis control circuit 207 performs feedback control on the control axes.

The spindle control circuit 208 is a circuit for controlling the spindle motor 7. The spindle control circuit 208 receives a control command from the hardware processor 201 and sends a command for driving the spindle motor 7 to the spindle amplifier 6. The spindle control circuit 208 sends a spindle speed command for controlling the rotation speed of the spindle motor 7, for example, to the spindle amplifier 6.

The spindle amplifier 6 receives the command from the spindle control circuit 208 and supplies a current to the spindle motor 7.

The spindle motor 7 is driven upon receipt of the current supply from the spindle amplifier 6. The spindle motor 7 is coupled to a spindle in order to rotate the spindle.

The PLC 209 is a device for controlling the auxiliary device 8 by executing a ladder program. The PLC 209 sends a command to the auxiliary device 8 through the I/O unit 210.

The I/O unit 210 is an interface connecting the PLC 209 and the auxiliary device 8. The I/O unit 210 sends the command received from the PLC 209 to the auxiliary device 8.

The auxiliary device 8 is a device that is disposed in the machine tool 1 in order to perform an auxiliary operation in the machine tool 1. The auxiliary device 8 operates on the basis of a command received from the I/O unit 210. The auxiliary device 8 may also be a device disposed on the periphery of the machine tool 1. For example, the auxiliary device 8 is a tool exchanging device, a cutting fluid injection device, or an opening/closing door driving device.

The second interface 211 is an interface connecting the bus 202 and the microphone 9. The second interface 211 sends speech information output from the microphone 9, for example, to the hardware processor 201.

The microphone 9 is an acoustic device that acquires speech and converts the speech into speech information. Here, the speech information is an electric signal. The microphone 9 sends the speech information to the hardware processor 201 through the second interface 211.

Next, functions of the speech recognition device 20 will be described.

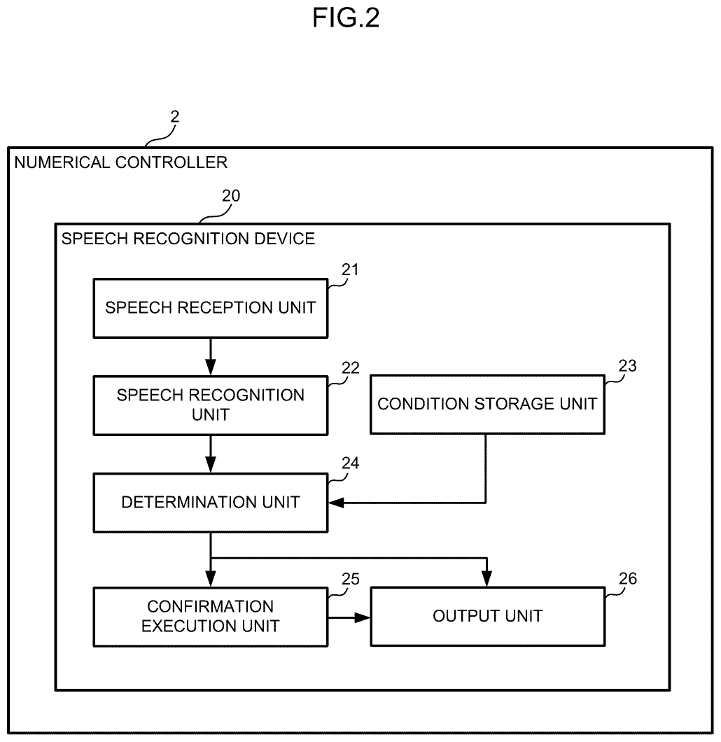

FIG. 2 is a block diagram showing examples of functions of the speech recognition device 20 packaged in the numerical controller 2. The speech recognition device 20 includes a speech reception unit 21, a speech recognition unit 22, a condition storage unit 23, a determination unit 24, a confirmation execution unit 25, and an output unit 26.

The speech reception unit 21, the speech recognition unit 22, the determination unit 24, the confirmation execution unit 25, and the output unit 26 are realized by, for example, having the hardware processor 201 perform calculation processing using the system program and speech recognition program stored in the ROM 203 and the various data stored in the nonvolatile memory 205. The condition storage unit 23 is realized by storing various data in the RAM 204 or the nonvolatile memory 205.

The speech reception unit 21 receives speech information about speech uttered by a user. The speech uttered by the user includes commands to the numerical controller 2, for example. For example, the user utters speech indicating a single command among a plurality of commands. In other words, the speech reception unit 21 receives speech information indicating a single command among a plurality of commands.

The speech reception unit 21 receives input of the speech information from the microphone 9, for example. The speech information is an analog signal indicating speech uttered by a speaker, for example. The speech information may be a digital signal acquired by converting the analog signal indicating the speech.

The speech recognition unit 22 performs speech recognition on the single command on the basis of the speech information received by the speech reception unit 21, and calculates the reliability of a recognition result of the single command. In other words, the speech recognition unit 22 recognizes the type of command expressed by the speech information. Here, functions of the speech recognition unit 22 will be described in detail.

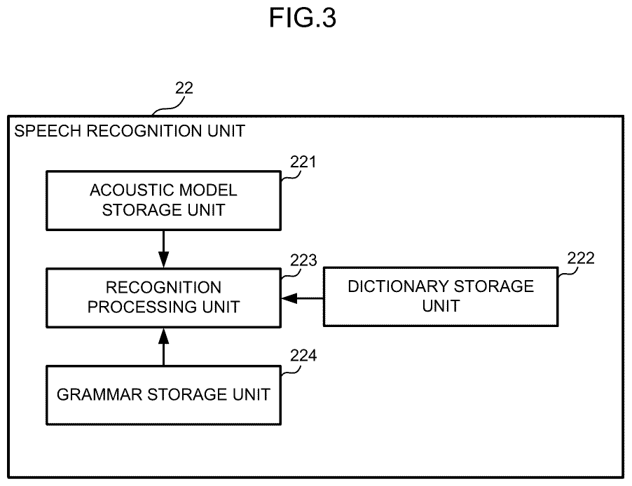

FIG. 3 is a block diagram showing examples of the functions of the speech recognition unit 22. The speech recognition unit 22 includes an acoustic model storage unit 221, a dictionary storage unit 222, a recognition processing unit 223, and a grammar storage unit 224.

The acoustic model storage unit 221 stores an acoustic model for distinguishing phonemes included in the speech information. The acoustic model is used to distinguish phonemes by extracting features from a waveform of the speech uttered by the speaker. The features are the strength and the frequency characteristics of the speech, for example.

The acoustic model is generated by, for example, performing machine learning using the speech information of the speech uttered by the speaker as teaching data. The acoustic model storage unit 221 may store a plurality of acoustic models corresponding to respective languages.

The dictionary storage unit 222 stores a dictionary. The dictionary includes, for example, commands that are used when performing various operations or various settings on the numerical controller 2. The dictionary may also include specialist terminology used when performing various operations or various settings on the numerical controller 2.

The recognition processing unit 223 uses the acoustic model to determine a sequence of phonemes indicated by the speech information. For example, when speech corresponding to the Japanese term “gaibu intafeesu” (“external interface”) is uttered, the Japanese phoneme sequence “gaibuiNtafe:su”, which corresponds to “gaibu intafeesu”, is determined by the recognition processing unit 223. Further, the recognition processing unit 223 uses the dictionary stored in the dictionary storage unit 222 to determine a character string and a sequence of words that match the sequence of phonemes. For example, the recognition processing unit 223 determines that the phoneme sequence “gaibuiNtafe: su” matches a character string corresponding to the Japanese term “gaibu intafeesu”.

The grammar storage unit 224 stores a grammar model that defines rules for constructing sentences. The grammar model indicates the probability of the appearance of a word in the speech information. In other words, the grammar model indicates the probability that a certain word will be followed by another word. The grammar model is used to evaluate whether or not the character string or the sequence of words is suitable as language. The grammar model is also known as a language model.

The recognition processing unit 223 uses the dictionary and the grammar model to recognize the speech information so that the speech information forms a character string and a sequence of words that are suitable as language. In other words, the recognition processing unit 223 determines an appropriate character string and word sequence candidate from the speech information. In short, the recognition processing unit 223 recognizes the command by performing speech recognition.

Furthermore, the recognition processing unit 223 calculates the reliability of the determined candidate. The reliability is a scale indicating how reliable the determined character string and word sequence are. The reliability is determined within a range of 0.0 to 1.0 inclusive. When the reliability has a small value, this means many other candidates which are similar to the determined character string and word sequence have been found. When the reliability has a large value, on the other hand, this means that there are no or few other candidates that are similar to the determined character string and word sequence. The N-best method, for example, is used as a method for calculating the reliability.

The condition storage unit 23 stores a plurality of conditions that are used to determine whether or not to execute a confirmation process on the recognition result respectively in association with the plurality of commands. The confirmation process is a process in which the user accepts or rejects the recognition result of the speech information in accordance with whether or not the recognition result is correct. The conditions are thresholds, for example. When the conditions are thresholds, the condition storage unit 23 stores a plurality of thresholds respectively in association with the plurality of commands.

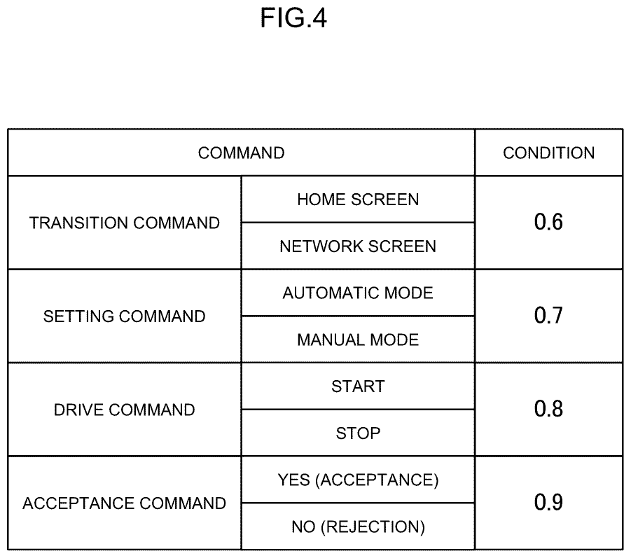

FIG. 4 is a diagram showing examples of the commands and conditions stored in the condition storage unit 23. For example, the condition storage unit 23 stores a transition command, a setting command, a drive command, and an acceptance command.

The transition command is a command for transitioning a display screen. The transition command includes a home screen command and a network screen command. The home screen command is a command for transitioning the display screen to a home screen. The network screen command is a command for transitioning the display screen to a network screen.

The setting command is a command for performing mode setting. The setting command includes an automatic mode command and a manual mode command. The automatic mode command is a command for setting the operating mode of the numerical controller 2 to an automatic mode. The manual mode command is a command for setting the operating mode of the numerical controller 2 to a manual mode.

The drive command is a command for driving at least one of the spindle and the control axes. The drive command includes a start command and a stop command. The start command is a command for starting to drive at least one of the spindle and the control axes. The stop command is a command for stopping driving at least one of the spindle and the control axes.

The acceptance command is a command for accepting or rejecting a confirmation item on a confirmation screen. The confirmation screen is a screen for displaying confirmation items on the display screen. The acceptance command includes a yes command and a no command. The yes command is a command for accepting the confirmation item. The no command is a command for rejecting the confirmation item.

The condition storage unit 23 stores a plurality of conditions corresponding respectively to these commands. The conditions stored by the condition storage unit 23 are, for example, thresholds that are compared with the reliability of the recognition result calculated by the speech recognition unit 22.

For example, the condition storage unit 23 stores 0.6 as the condition corresponding to the transition command. Further, the condition storage unit 23 stores 0.7 as the condition corresponding to the setting command. Furthermore, the condition storage unit 23 stores 0.8 as the condition corresponding to the drive command. Furthermore, the condition storage unit 23 stores 0.9 as the condition corresponding to the acceptance command.

The determination unit 24 determines whether or not to execute the confirmation process on the basis of one condition among the plurality of conditions stored in the condition storage unit 23, and the reliability calculated by the speech recognition unit 22. For example, when the speech information is recognized as the transition command, the determination unit 24 determines whether or not to execute the confirmation process by comparing the reliability calculated by the speech recognition unit 22 with the condition “0.6” stored in association with the transition command.

When the reliability calculated by the speech recognition unit 22 equals or exceeds 0.6, the determination unit 24 determines that the confirmation process is not to be executed. Further, when the reliability calculated by the speech recognition unit 22 is less than 0.6, the determination unit 24 determines that the confirmation process is to be executed.

Similarly, when the command recognized by the speech recognition unit 22 is the setting command and the calculated reliability is 0.7 or more, the determination unit 24 determines that the confirmation process is not to be executed. Further, when the command recognized by the speech recognition unit 22 is the setting command and the calculated reliability is less than 0.7, the determination unit 24 determines that the confirmation process is to be executed.

Similarly, when the command recognized by the speech recognition unit 22 is the drive command and the calculated reliability is 0.8 or more, the determination unit 24 determines that the confirmation process is not to be executed. Further, when the command recognized by the speech recognition unit 22 is the drive command and the calculated reliability is less than 0.8, the determination unit 24 determines that the confirmation process is to be executed.

Similarly, when the command recognized by the speech recognition unit 22 is the acceptance command and the calculated reliability is 0.9 or more, the determination unit 24 determines that the confirmation process is not to be executed. Further, when the command recognized by the speech recognition unit 22 is the acceptance command and the calculated reliability is less than 0.9, the determination unit 24 determines that the confirmation process is to be executed.

When the determination unit 24 determines that the confirmation process is to be executed, the confirmation execution unit 25 executes the confirmation process.

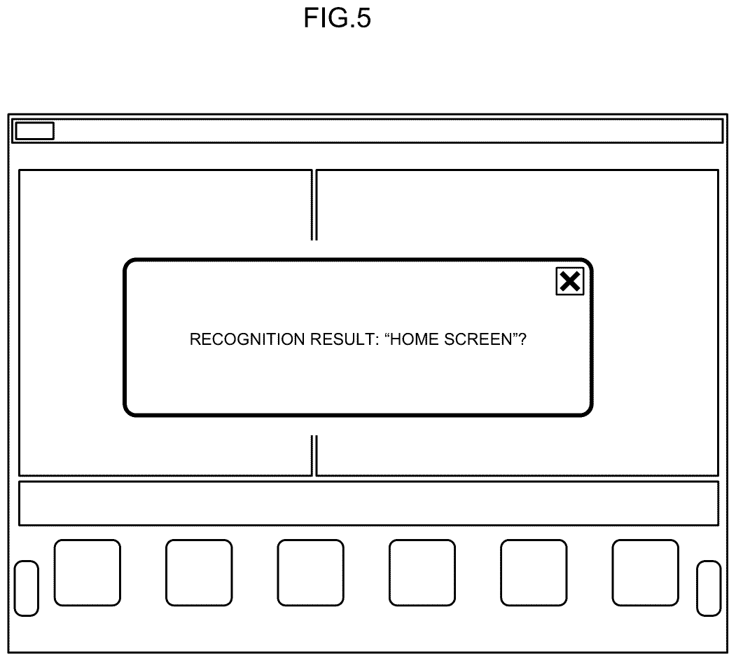

FIG. 5 is a diagram showing an example of a confirmation screen displayed in the confirmation process. FIG. 5 shows an example of a confirmation screen in a case where the speech information has been recognized by the speech recognition unit 22 as indicating “home screen”. When the confirmation screen is displayed, the user inputs acceptance information. The acceptance information is information indicating acceptance or rejection of the recognition result. For example, the user utters the word “yes” to indicate acceptance or the word “no” to indicate rejection. These words are input as the acceptance information.

In the confirmation process, the speech reception unit 21 receives the acceptance information indicating acceptance or rejection of the recognition result of the speech information. The speech recognition unit 22 performs speech recognition on the acceptance information received by the speech reception unit 21, and calculates the reliability of the recognition result of the acceptance information. In other words, the speech recognition unit 22 recognizes the acceptance information as “yes” or “no”, and calculates the reliability of the corresponding recognition result. Note that the acceptance information may be identical to the acceptance command stored in the condition storage unit 23.

The determination unit 24 determines, on the basis of the condition stored in the condition storage unit 23 in association with the acceptance command and the reliability of the acceptance information, calculated by the speech recognition unit 22, whether or not to output the recognition result of the speech information recognized prior to the confirmation process. In other words, the determination unit 24 determines whether or not to output the recognition result of the command uttered by the user in accordance with the recognition result of the acceptance information and whether or not the reliability of the acceptance information satisfies the condition.

For example, when the acceptance information recognized by the speech recognition unit 22 is “yes” and the calculated reliability of the acceptance information equals or exceeds 0.9, the determination unit 24 determines that the recognition result of the command uttered by the user is to be output. In this case, the user confirms that the recognition result of the command recognized by the speech recognition unit 22 is correct.

Further, when the acceptance information recognized by the speech recognition unit 22 is “no” and the calculated reliability of the acceptance information equals or exceeds 0.9, the determination unit 24 determines that the recognition result of the speech information recognized prior to the confirmation process is not to be output. In this case, the user confirms that there is an error in the recognition result of the command recognized by the speech recognition unit 22.

Furthermore, when the acceptance information recognized by the speech recognition unit 22 is “yes” or “no” and the calculated reliability of the acceptance information is less than 0.9, the determination unit 24 determines that the recognition result is not to be output. These cases mean that it is not reliably clear whether the recognition result of the acceptance information is correct or erroneous.

When the determination unit 24 determines that the recognition result of the command is to be output, the output unit 26 outputs the recognition result. The output unit 26 outputs the recognition result to a control unit (not shown) of the numerical controller 2, for example. Accordingly, the control unit can execute the command indicated by the recognition result. Furthermore, the output unit 26 may display the command indicated by the recognition result on the display screen of the input/output device 3.

When the determination unit 24 determines that the recognition result is not to be output, the speech recognition unit 22 may receive the speech information indicating the command again. Thus, when the speech recognition device 20 fails to recognize the speech once, the speech recognition device 20 can execute speech recognition on the command again.

Next, a flow of processing executed in the speech recognition device 20 will be described. In the speech recognition device 20, processing is performed at a preparatory stage and at an operation stage.

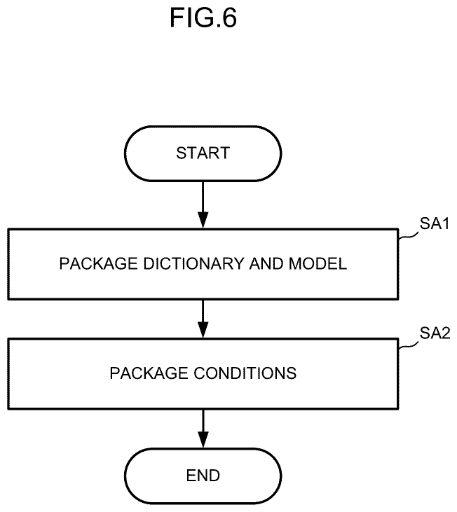

FIG. 6 is a flowchart showing an example of the processing executed by the speech recognition device 20 at the preparatory stage. At the preparatory stage, first, a grammar model, a dictionary, and an acoustic model generated in accordance with a plurality of commands are packaged in the speech recognition device 20 (step SA1). In other words, the acoustic model storage unit 221 stores the acoustic model. Further, the dictionary storage unit 222 stores the dictionary. Furthermore, the grammar storage unit 224 stores the grammar model. Note that the commands are designed in accordance with the machine tool 1, the factory in which the machine tool 1 is disposed, the operator, and so on, for example.

Next, the plurality of conditions used to determine whether or not to execute the confirmation process are packaged in the speech recognition device 20 (step SA2). In other words, the condition storage unit 23 stores the plurality of conditions that are used to determine whether or not to execute the confirmation process respectively in association with the plurality of commands. That completes the processing performed at the preparatory stage.

Next, the processing performed at the operation stage will be described.

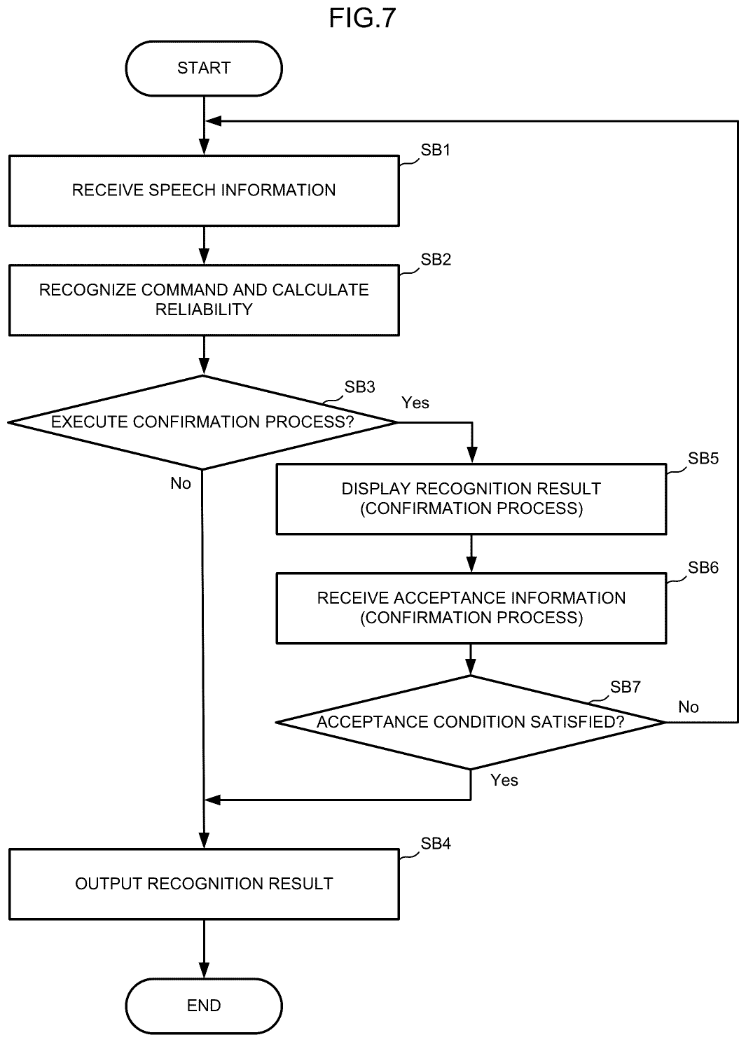

FIG. 7 is a flowchart showing an example of the processing executed by the speech recognition device 20 at the operation stage. At the operation stage, first, the speech reception unit 21 receives speech information indicating a single command among the plurality of commands (step SB1).

Next, the speech recognition unit 22 performs speech recognition on the single command and calculates the reliability of the recognition result of the single command (step SB2).

Next, the determination unit 24 determines whether or not to execute the confirmation process (step SB3).

When the determination unit 24 determines that the confirmation process is not to be executed (when No is obtained in step SB3), the output unit 26 outputs the recognition result (step SB4), whereupon the processing is terminated.

When the determination unit 24 determines that the confirmation process is to be executed (when Yes is obtained in step SB3), the confirmation execution unit 25 executes the confirmation process. In the confirmation process, the confirmation execution unit 25 displays the confirmation result on the display screen (step SB5). Next, the speech reception unit 21 receives the acceptance information (step SB6).

When the acceptance information indicates “yes” and the reliability of the acceptance information satisfies the condition (when Yes is obtained in step SB7), the output unit 26 outputs the recognition result (step SB4), whereupon the processing is terminated.

When the acceptance information indicates “yes” but the reliability of the acceptance information does not satisfy the condition, or when the acceptance information indicates “no” (when No is obtained in step SB7), the speech reception unit 21 receives the speech information again.

As described above, the speech recognition device 20 includes the speech reception unit 21 for receiving speech information indicating a single command among the plurality of commands, the speech recognition unit 22 for performing speech recognition on the single command on the basis of the speech information received by the speech reception unit 21, and calculating the reliability of the recognition result of the single command, the condition storage unit 23 for storing the plurality of conditions that are used to determine whether or not to execute the confirmation process on the recognition result respectively in association with the plurality of commands, the determination unit 24 for determining whether or not to execute the confirmation process on the basis of one condition among the plurality of conditions stored in the condition storage unit 23 and the reliability calculated by the speech recognition unit 22, and the output unit 26 for outputting the recognition result without executing the confirmation process when the determination unit 24 determines that the confirmation process is not to be executed.

Thus, with the speech recognition device 20, an improvement in user-friendliness can be achieved. More specifically, the confirmation process is reduced in accordance with the reliability of the recognition result of the command. In other words, the number of operations performed by the user on the speech recognition device 20 is reduced.

Note that the speech recognition device 20 may further include an updating unit for updating the conditions stored in the condition storage unit 23.

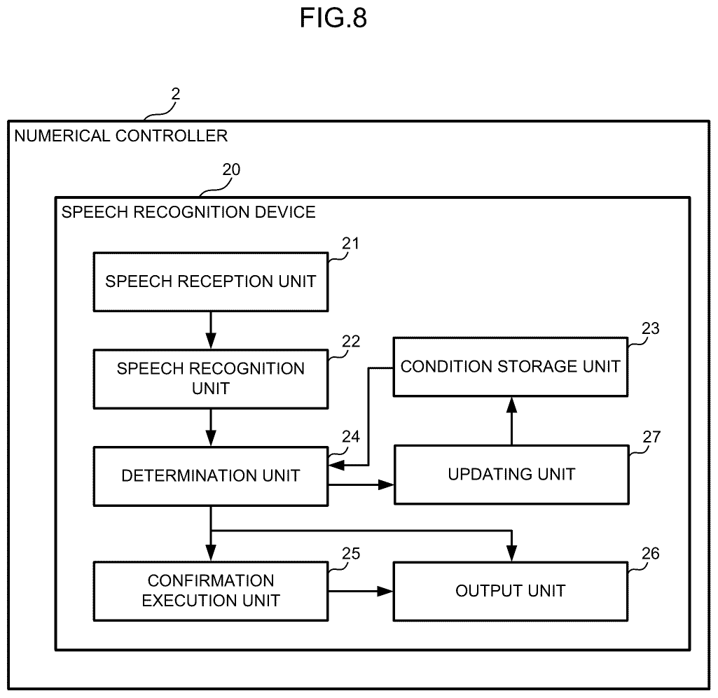

FIG. 8 is a block diagram showing examples of the functions of the speech recognition device 20 including an updating unit. Here, different functions from the functions of the speech recognition device 20 described using FIG. 2 will be described, and description of identical functions to those of the speech recognition device 20 of FIG. 2 has been omitted.

An updating unit 27 updates the one condition corresponding to the single command on the basis of the acceptance information received by the speech reception unit 21 in the confirmation process.

For example, even if the reliability of the recognition result of the setting command is “0.65”, which is smaller than the condition “0.7” stored in association with the setting command, as long as acceptance information indicating “yes” is input in the confirmation step, the recognition result acquired by the speech recognition unit 22 in relation to the setting command is correct. In other words, no problem will occur even if the value of the condition stored in association with the setting command is changed to “0.6”, which is lower than the calculated reliability. Accordingly, when acceptance information indicating acceptance is received by the speech reception unit 21 in the confirmation process, the updating unit 27 can change the numerical value indicated by the condition stored in association with the setting command to be smaller. By updating the condition using the updating unit 27, the confirmation process can be omitted the next time the speech recognition unit 22 recognizes the setting command. The updating unit 27 reduces the value of the condition by a predetermined numerical value, for example, each time the condition is updated.

The updating unit 27 may also update the one condition on the basis of a reception history of the acceptance information. The reception history of the acceptance information is a past record of the acceptance information indicating acceptance or rejection, received by the speech reception unit 21 in the confirmation process.

For example, when it is recorded in the history that acceptance information indicating acceptance has been input a plurality of times in confirmation processes performed on recognition results of the drive command, the updating unit 27 can update the condition stored in association with the drive command. More specifically, the updating unit 27 can update the value indicated by the condition stored in association with the drive command to be smaller.

The updating unit 27 may also update the one condition on the basis of system information. The system information is time information held by the speech recognition device 20 as system information, for example. For example, it is highly likely that during the day, a person in a managerial position, such as the factory manager, will be on duty. In other words, it is highly likely that a person who can take responsibility for changes to the conditions stored in the condition storage unit 23 will be on duty. Accordingly, the updating unit 27 may be configured so as to be capable of changing the conditions stored in the condition storage unit 23 from 9 AM to 5 PM, for example.

Note that in the example described in the above embodiment, the speech reception unit 21 receives the acceptance information indicating acceptance or rejection in the confirmation process in the form of speech information. However, the acceptance information may be received in the confirmation process through an operation performed on the display screen of the input/output device 3.

The present disclosure is not limited to the embodiment described above and may be modified as appropriate within a scope that does not depart from the spirit thereof. In the present disclosure, any of the constituent elements of the embodiment may be modified or omitted.

### REFERENCE SIGNS LIST

1 Machine tool
2 Numerical controller
20 Speech recognition device
21 Speech reception unit
22 Speech recognition unit
221 Acoustic model storage unit
222 Dictionary storage unit
223 Recognition processing unit
224 Grammar storage unit
23 Condition storage unit
24 Determination unit
25 Confirmation execution unit
26 Output unit
27 Updating unit
201 Hardware processor
202 Bus
203 ROM
204 RAM
205 Nonvolatile memory
206 First interface
207 Axis control circuit
208 Spindle control circuit
209 PLC
210 I/O unit
211 Second interface
3 Input/output device
4 Servo amplifier
5 Servo motor
6 Spindle amplifier
7 Spindle motor
8 Auxiliary device
9 Microphone

1. A speech recognition device comprising:
a speech reception unit for receiving speech information indicating a single command among a plurality of commands;
a speech recognition unit for performing speech recognition on the single command on the basis of the speech information received by the speech reception unit, and calculating a reliability of a recognition result of the single command;
a condition storage unit for storing a plurality of conditions that are used to determine whether or not to execute a confirmation process on the recognition result respectively in association with the plurality of commands;
a determination unit for determining whether or not to execute the confirmation process on the basis of one condition among the plurality of conditions stored in the condition storage unit and the reliability calculated by the speech recognition unit; and
an output unit for outputting the recognition result without executing the confirmation process when the determination unit determines that the confirmation process is not to be executed.

2. The speech recognition device according to claim 1, further comprising an updating unit for updating the one condition corresponding to the single command on the basis of acceptance information indicating acceptance or rejection of the recognition result, the acceptance information being received by the speech reception unit in the confirmation process.

3. The speech recognition device according to claim 2, wherein the one condition is a threshold, and
when the speech reception unit receives the acceptance information indicating acceptance in the confirmation process, the updating unit updates the threshold corresponding to the single command to be smaller.

4. The speech recognition device according to claim 2, wherein the updating unit also updates the one condition on the basis of a reception history of the acceptance information received by the speech reception unit and/or system information.

5. A computer-readable storage medium storing commands for causing a computer to execute:
receiving speech information indicating a single command among a plurality of commands;
performing speech recognition on the single command on the basis of the received speech information, and calculating a reliability of a recognition result of the single command;
determining whether or not to execute a confirmation process on the basis of one condition among a plurality of conditions that are used to determine whether or not to execute the confirmation process on the recognition result, the plurality of conditions being stored respectively in association with the plurality of commands, and the calculated reliability; and
outputting the recognition result without executing the confirmation process when it is determined that the confirmation process is not to be executed.
